(19) United States
(12) Patent Application Publication
(10) Pub. No.: US 2024/0294155 A1
(43) Pub. Date: Sep. 5, 2024

(54) BRAKE SYSTEMS HAVING STAELLITE RESERVOIRS

(71) Applicant: ZF Active Safety US Inc., Livonia, MI (US)

(72) Inventor: Blaise Ganzel, Ann Arbor, MI (US)

(21) Appl. No.: 18/420,810

(22) Filed: Jan. 24, 2024

Related U.S. Application Data
(60) Provisional application No. 63/449,464, filed on Mar. 2, 2023.

(51) Int. Cl. B60T 8/40; B60T 8/88

(52) U.S. Cl. CPC B60T 8/409; B60T 8/88; B60T 2270/402

(57) ABSTRACT

A brake system for actuating a plurality of wheel brakes includes a reservoir and a master cylinder in fluid communication with the reservoir and operable during a backup braking mode to generate pressurized hydraulic fluid. A plurality of single corner actuators is provided. Each single corner actuator is hydraulically interposed between the at least one MC output and a corresponding one of the first and second wheel brakes. Each single corner actuator includes a SCA power transmission unit configured for selectively providing pressurized hydraulic fluid at an SCA output. A plurality of satellite reservoirs is provided. Each satellite reservoir is interposed hydraulically between the SCA power transmission unit and the master cylinder along the at least one MC output. Each single corner actuator is indirectly fluidly connected to the reservoir via the master cylinder and the satellite reservoir.

### RELATED APPLICATIONS

This application claims priority from U.S. Provisional Application No. 63/449,464, filed 2 Mar. 2023, the subject matter of which is incorporated herein by reference in its entirety.

This application is related to the technologies disclosed in one or more of U.S. Provisional Patent Application No. 63/580,042 (attorney docket no. 301699-US-PSP), filed 1 Sep. 2023 and titled “Brake Systems with Motor-Driven Master Cylinders and Low Pressure Accumulators”; U.S. Provisional Patent Application No. 63/580,048 (attorney docket no. 301647-US-PSP), filed 1 Sep. 2023 and titled “Brake Systems with Motor-Driven Master Cylinders and Pump Inlet Attenuators”; U.S. Provisional Patent Application No. 63/518,687 (attorney docket no. 300063-US-PSP [3]), filed 10 Aug. 2023 and titled “Push Thru SCA”; U.S. patent application Ser. No. 18/447,541 (attorney docket no. 300100-US-NP), filed 10 Aug. 2023 and titled “Brake Systems with Motor-Driven Master Cylinders and Electric Secondary Power Transmission Units”; U.S. patent application Ser. No. 18/447,566 (attorney docket no. 300510-US-NP), filed 10 Aug. 2023 and titled “Brake Systems with Motor-Driven Master Cylinders and Wheel-Side Pressure Sensors”; U.S. patent application Ser. No. 18/447,609 (attorney docket no. 300642-US-NP), filed 10 Aug. 2023 and titled “Venting Valve and Brake Systems Using Same”; U.S. patent application Ser. No. 18/447,490 (attorney docket no. 300080-US-NP), filed 10 Aug. 2023 and titled “Brake Systems with Master Cylinders and Single Corner Actuators”, hereafter referenced as “the '490 application”; and U.S. patent application Ser. No. 18/447,642 (attorney docket no. 301149-US-NP), filed 10 Aug. 2023 and titled “Bleed Valve and Brake Systems Using Same”; the entire contents of all of which are incorporated herein by reference for all purposes.

### TECHNICAL FIELD

This disclosure relates to an apparatus and method for use for brake systems, and, more particularly, to methods and apparatus of brake systems having satellite reservoirs.

### BACKGROUND

A brake system may include anti-lock control including a hydraulic braking pressure generator, a braking pressure modulator which is provided in the pressure fluid conduits between the braking pressure generator and the wheel brakes and which serves to vary the braking pressure by changing the volume of a chamber containing the hydraulic fluid, sensors for determining the wheel rotational behavior, and electronic circuits for processing the sensor signals and for generating braking-pressure control signals. Brake systems may also include both anti-lock control and traction slip control, which can use braking pressure modulators for controlled vehicular braking.

Certain brake systems include at least one source of pressurized fluid located at or adjacent to the wheel brakes. An example of such a system is disclosed in the '490 application.

### SUMMARY

In an aspect, a brake system for actuating a plurality of wheel brakes comprising at least first and second wheel brakes is provided. The system comprises a reservoir and a master cylinder in fluid communication with the reservoir and operable during a backup braking mode to generate pressurized hydraulic fluid at at least one MC output for hydraulically actuating the first and second wheel brakes. A plurality of single corner actuators is provided. Each single corner actuator is hydraulically interposed between the at least one MC output and a corresponding one of the first and second wheel brakes. Each single corner actuator includes a SCA power transmission unit configured for selectively providing pressurized hydraulic fluid at an SCA output for actuating the respective wheel brake in at least one of a normal non-failure braking mode and a backup braking mode. The SCA power transmission unit includes an electric PTU motor configured to selectively pressurize the hydraulic fluid by transmitting rotary motion to a plunger assembly of the SCA power transmission unit. A plurality of satellite reservoirs is provided. Each satellite reservoir is interposed hydraulically between the SCA power transmission unit and the master cylinder along the at least one MC output. An electronic control unit controls at least one SCA power transmission unit responsive to at least one brake pressure signal. Each single corner actuator is indirectly fluidly connected to the reservoir via the master cylinder and the satellite reservoir.

### BRIEF DESCRIPTION OF THE DRAWINGS

For a better understanding, reference may be made to the accompanying drawings, in which:

FIG. 1 is a schematic hydraulic diagram of a first example brake system;

FIG. 2 is a schematic hydraulic diagram of a second example brake system; and

FIG. 3 is a schematic hydraulic diagram of a third example brake system.

### DESCRIPTION OF ASPECTS OF THE DISCLOSURE

Unless defined otherwise, all technical and scientific terms used herein have the same meaning as is commonly understood by one of ordinary skill in the art to which the present disclosure pertains.

The invention comprises, consists of, or consists essentially of the following features, in any combination.

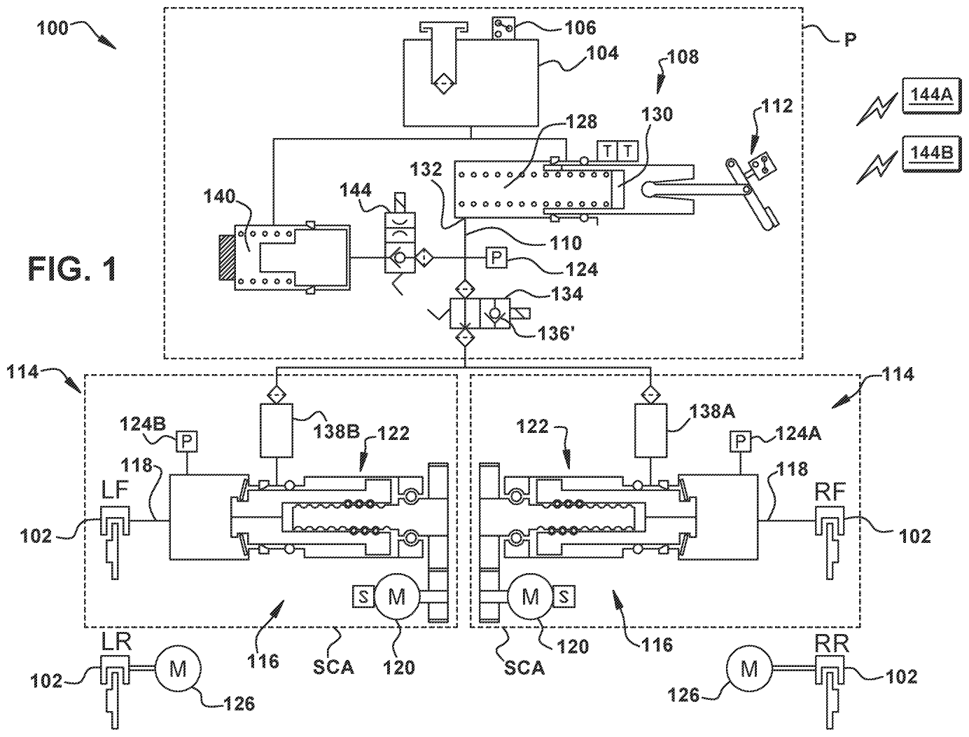

FIGS. 1-3 each schematically depict a first, second, or third configuration, respectively, of an example brake system 100 for actuating a plurality of wheel brakes 102, such as first and second wheel brakes LF and RF, as shown. The brake system 100 is shown here as a hydraulic braking system, in which fluid pressure is utilized to apply braking forces for the brake system 100. The brake system 100 may suitably be used on a ground vehicle, such as an automotive vehicle having four wheels with a wheel brake associated with each wheel. Furthermore, the brake system 100 can be provided with other braking functions such as anti-lock braking (ABS) and other slip control features to effectively brake the vehicle. Components of the brake system 100 may be housed in one or more blocks or housings. The blocks or housings may be made from solid material, such as aluminum, that has been drilled, machined, or otherwise formed to house the various components. Fluid conduits may also be formed in the block or housing.

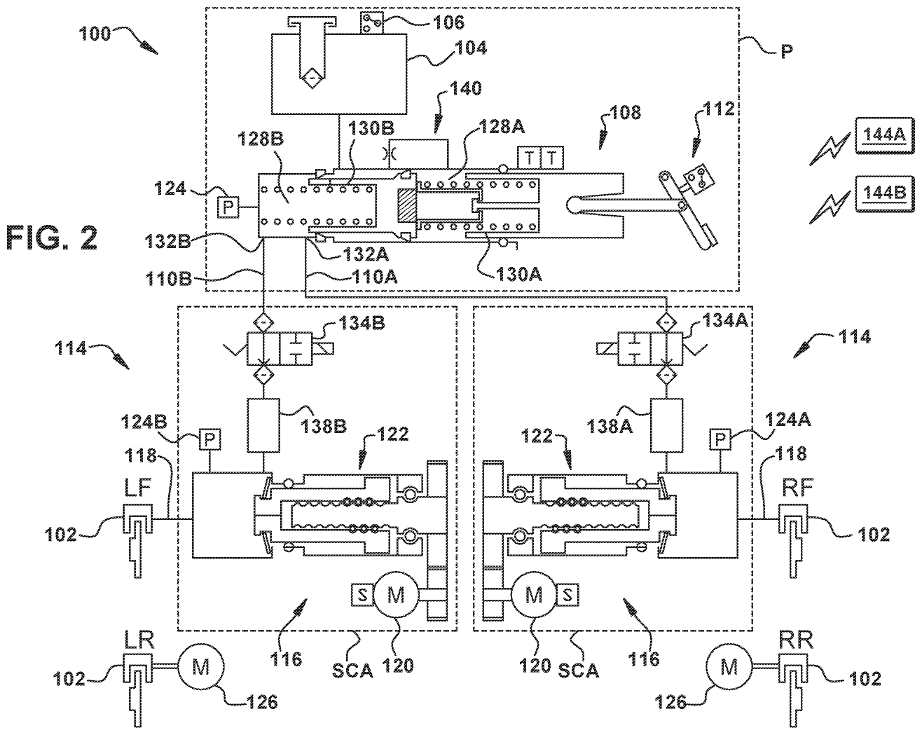

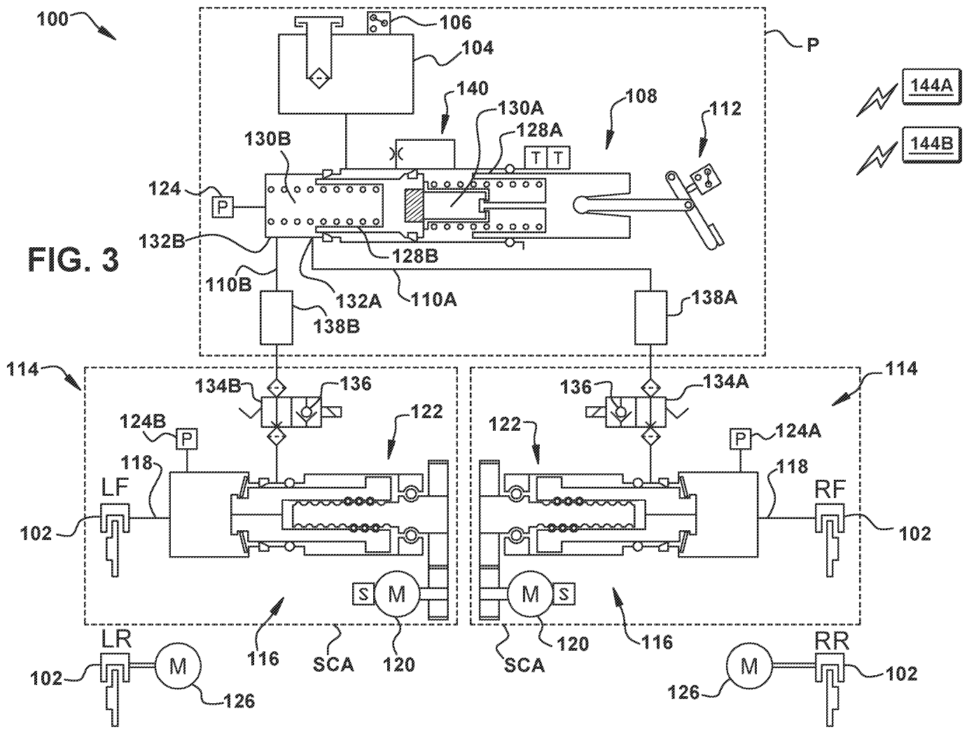

The brake systems 100 of FIGS. 2-3 are similar to the brake system 100 of FIG. 1 and therefore, structures of FIGS. 2-3 that are the same as or similar to those described with reference to FIG. 1 have the same reference numbers. Description of common elements and operation similar to those in the previously described configuration will not be repeated with respect to the brake systems 100 of FIGS. 2-3, but should instead be considered to be incorporated below by reference as appropriate.

In the illustrated embodiments of the brake system 100, there are four wheel brakes 102, which each can have any suitable wheel brake structure operated electrically and/or by the application of pressurized brake fluid. Each of the wheel brakes 102 may include, for example, a brake caliper mounted on the vehicle to engage a frictional element (such as a brake disc) that rotates with a vehicle wheel to effect braking of the associated vehicle wheel. The wheel brakes 102 can be associated with any combination of front and rear wheels of the vehicle in which the corresponding brake system 100 is installed. No differentiation is made herein among the wheel brakes 102, for the purposes of this description, though one of ordinary skill in the art could readily provide a suitable braking arrangement for a particular use environment.

The brake system 100 also includes a fluid reservoir 104. The reservoir 104 stores and holds hydraulic fluid for the brake system 100. The fluid within the reservoir 104 is preferably held at or about atmospheric pressure, but the fluid may be stored at other pressures if desired. Any number of lines could be connected to the reservoir 104, and one of ordinary skill in the art can readily provide a suitably configured reservoir 104 for a particular use environment. Alternatively, the reservoir 104 may include multiple separate housings. The reservoir 104 may include at least one fluid level sensor 106 for detecting the fluid level of one or more of the sections of the reservoir 104. The reservoir 104 shown in the Figures is a single-chamber reservoir.

A manually operable master cylinder 108 is in fluid communication with the reservoir 104 and is operable during a backup braking mode to generate pressurized hydraulic fluid at at least one MC output 110 (shown in FIGS. 2-3 as first and second MC outputs 110A and 110B, respectively), for hydraulically actuating the first and second wheel brakes LF and RF (via first and second MC outputs 110A and 110B in FIGS. 2-3, respectively). This backup braking mode is termed “manual push-through” and can result in the provision of pressurized hydraulic fluid in a known manner when other portions of the brake system 100 are not available for use for some reason. The master cylinder (“MC”) 108 shown in the Figures is operable to generate pressurized fluid responsive to user manipulation (manual force) applied to a brake pedal 112 mechanically connected to the master cylinder 108 by a user. In turn, the brake pedal is configured to provide a braking signal, in a wired or wireless manner, corresponding to a desired braking action by an operator of the vehicle, as will be discussed further below.

Each brake system 100 of FIGS. 1-3 also includes a plurality of single corner actuators 114 (“SCA”s). Each single corner actuator 114 is hydraulically interposed between the at least one MC output 110 and a corresponding one of the first and second wheel brakes 102 RF and LF. Each SCA 114 includes a SCA power transmission unit (“PTU”) 116 configured for selectively providing pressurized hydraulic fluid at an SCA output 118 for actuating the respective wheel brake in at least one of a normal non-failure braking mode and a backup braking mode, though it is contemplated that the SCA 114 will normally be used to provide pressurized hydraulic fluid to a corresponding wheel brake 102 in the normal non-failure braking mode. The secondary PTU 116 includes an electric PTU motor 120 configured to selectively pressurize the hydraulic fluid by transmitting rotary motion to a plunger assembly 122 of the secondary PTU 116. Each single corner actuator 114 may be indirectly fluidly connected to the reservoir 104 via the master cylinder 108.

Each single corner actuator 114 may include a brake pressure sensor 124 for sensing hydraulic pressure at the plunger assembly 122 of the SCA power transmission unit 116 and responsively producing a brake pressure signal. That is, at least two brake pressure sensors 124 may be provided to the brake system 100, with brake pressure sensors 124A, 124B being optionally located directly hydraulically adjacent a corresponding wheel brake 102 RF or LF, as shown in the Figures, for sensing hydraulic pressure at the corresponding wheel brake 102 RF or LF and responsively producing a brake pressure signal. Other locations for brake pressure sensors 124 include, but are not limited to, at the master cylinder 108, and/or any other location as desired by one of ordinary skill in the art for a particular use environment.

The brake system 100 may include third and fourth wheel brakes 102, labeled as LR and RR, respectively. Each of the third and fourth wheel brakes LR and RR may be actuated by at least one of an electric brake motor 126 and an additional, separately provided single corner actuator (not shown, but substantially similar to the SCAs 114 discussed herein and shown as associated with the first and second wheel brakes LF and RF in the Figures. One of ordinary skill in the art can readily configure a brake system 100 to include any desired number, configuration, arrangement, and/or type of electric and/or hydraulic power sources.

As shown in the brake system 100 of FIG. 1, the master cylinder 108 may be a single chamber master cylinder 108 including an MC chamber 128 and an MC plunger 130 configured for reciprocal motion therein to provide pressurized hydraulic fluid at a single-chamber output 132 serving as the at least one MC output 110. The at least one MC output 110 of the brake system 100 of FIG. 1 is in fluid communication with the single corner actuators 114 via a single normally open brake iso valve 134 interposed hydraulically between the master cylinder 108 and at least a selected one of the plurality of single corner actuators 114 for selectively controlling provision of hydraulic fluid to the respective wheel brake 102 from the master cylinder 108.

In contrast, and as shown in FIGS. 2-3, the master cylinder 108 may be a dual master cylinder 108 including first and second MC chambers 128A and 128B and corresponding first and second MC plungers 130A, 130B configured for reciprocal motion therein. The at least one single-chamber output 132, as shown In FIGS. 2-3 comprises first and second single-chamber outputs 132A and 132B. The second MC chamber 128B provides pressurized hydraulic fluid at the first and second single-chamber outputs 132A and 132B, corresponding to first and second single corner actuators 114, respectively. In the brake systems 100 shown in FIGS. 2-3, the first and second MC plungers 130A, 130B may each have substantially different outer circumference sizes, with the first MC plunger 130A being slightly larger in cross-sectional area than the second MC plunger 130B, but it is contemplated that each of the first and second MC plungers 130A, 130B could have substantially the same outer circumference size, for particular use environments.

In the brake systems 100 shown in the Figures, at least one normally open iso valve 134 is interposed hydraulically between the master cylinder 108 and the respective first or second single corner actuator 114 for selectively controlling provision of hydraulic fluid to the respective wheel brake 102 from the master cylinder 108. The normally open iso valve 134 allows flow of pressurized hydraulic fluid to a plunger assembly 122 of the single corner actuator 114—and thus indirectly to the respective wheel brake 102—from the master cylinder 108 when the iso valve 134 is de-energized (e.g., when the brake system 100 is in a backup braking mode, such as when the single corner actuator 114 is not operating. However, the iso valve 134 can be closed (e.g., when the brake system 100 is in a normal non-failure braking mode) to allow the plunger assembly 122 of the single corner actuator 114 to build pressure and thus directly supply pressurized hydraulic fluid to the wheel brake 102.

A check valve feature 136 of the iso valve 134 may be interposed hydraulically between the respective single-chamber output 132 and the SCA power transmission unit 116, for use when the iso valve 134 is energized closed. The check valve feature 136, when present, may selectively permit pressure release from the SCA power transmission unit 116 back toward the master cylinder 108 (and thus indirectly toward the reservoir 104) for any desired reason such as, but not limited to, due to development of a predetermined amount of thermal expansion in the secondary PTU 116.

The brake systems 100 shown in FIGS. 1-3 also include a plurality of satellite reservoirs 138, with two satellite reservoirs 138A 138B shown in each of the Figures. Each satellite reservoir 138 is interposed hydraulically between a corresponding SCA power transmission unit 116 of the single corner actuator 114 and the master cylinder 108 along the corresponding at least one MC output 110. Each single corner actuator 114 is indirectly fluidly connected to the reservoir 104 via the master cylinder 108 and the satellite reservoir 138. In one example arrangement, shown in FIG. 1, the at least one normally open iso valve 134 comprises a single iso valve 134 interposed hydraulically between the master cylinder 108 and the at least one satellite reservoir 138 (two shown in FIG. 1—so, interposed between the master cylinder 108 and the two satellite reservoirs 138).

Conversely, and as shown in FIGS. 2-3, the at least one normally open iso valve 134 can comprise first and second iso valves 134A and 134B, respectively. Each iso valve 134A, 134B may be hydraulically interposed between the master cylinder 108 and a corresponding one of the plurality of satellite reservoirs 138A, 138B, as shown in FIG. 2. One of ordinary skill in the art will note that the iso valves 134A, 134B shown in FIG. 2 do not include the previously described check valve features 136. This is at least partially because fluid “escaping” the single corner actuators 114A, 114B in the brake system 100 of FIG. 2 can be held, at least temporarily, in the corresponding satellite reservoir 138A, 138B. The SCA power transmission units 116 of FIG. 2 cannot build pressure on their own; the flow paths between the master cylinder 108 and the SCA power transmission units 116 will be blocked in the FIG. 2 arrangement. As a result, the FIG. 2 brake system 100 can use simpler SCA power transmission units 116 than those of FIGS. 1 and 3, but it also results in at least one valve of the system (e.g., iso valves 134) to be de-energized to vent the wheel brakes 102 in the FIG. 2 arrangement.

It should be noted that the satellite reservoirs 138A, 138B of the brake system 100 of FIG. 2 will likely see higher hydraulic pressures than those of the brake system 100 of FIG. 3, since they are “upstream” of the iso valves 134A, 134B in the latter. More specifically, the satellite reservoirs 138 will see different pressures during normal boosted operation in all three brake systems 100 shown in FIGS. 1-3. The satellite reservoir pressure would normally be very low in the FIG. 1 arrangement, it would correspond to boosted/brake pressure in the FIG. 2 arrangement, and it would correspond to MC pressure in the FIG. 3 arrangement. The satellite reservoir pressure in the FIG. 1 arrangement, however, could go up to boost pressure if there is seal leakage or a predetermined amount of thermal expansion. In some use environments, maximum boost pressure may be up to the range of between about 180 bar and about 220 bar, but a boost pressure range of 10 to 20 bar is generally more typical. The MC pressure is much lower than boost pressure for most use environments, and will be based on what is desired for a manual push through operation. Since there is only manual push through on the front wheel brakes 102 in the brake systems 100 shown and described herein, the MC pressure will be about 25% of the boosted pressure, but it may be higher on little cars and lower on big trucks.

As shown in the brake system 100 depicted in FIG. 3, the at least one normally open iso valve 134 can comprise first and second iso valves 134A and 134B, with each iso valve 134 being hydraulically interposed between a corresponding one of the plurality of satellite reservoirs 138 and a corresponding one of the SCA power transmission units 116. As previously mentioned, the satellite reservoirs 138 will likely see lower pressures in the brake system 100 of FIG. 3 than in the brake system of FIG. 2 due to the relative locations and/or differences in the design of the SCA power transmission units 116, as previously mentioned.

In all of the depicted brake systems 100, the satellite reservoirs 128 may be of any desired type and may include any desired filtering, sensing, and/or fluid control features. However, it is contemplated that, for most use environments, the satellite reservoirs 128 will be simple voids in a block housing or otherwise be “dumb” mechanisms simply providing capacity in the brake system 100 to assist with providing hydraulic fluid to the corresponding single corner actuator 114 as desired. For example, a satellite reservoir 128 may be used to store fluid for provision to a corresponding single corner actuator 114 in case there is an external leak in the other single corner actuator 114 circuit that drains the reservoir 104. Accordingly, the brake systems 100 of FIGS. 1-3 can be used, for example, on vehicles for which it is desired to retain braking capacity on at least one front brake even if the other fails.

A brake simulator (shown generally at 140 in the Figures) may be provided in hydraulic connection to the master cylinder 108 (i.e., in fluid communication with at least a selected one of the MC outputs 110) and directly or indirectly to the reservoir 104 for providing desired brake pedal response to the user, assisting with routing hydraulic fluid between other components of the brake system 100, or for any other reason. This is the arrangement shown in FIG. 1, with a brake simulator 140 and a brake simulator valve 142 (interposed hydraulically between the at least one MC output 110 and the brake simulator 140 for controlling fluid transfer therebetween) working in concert to provide the brake simulator 140 function in a known manner. One of ordinary skill in the art will note that no simulator test valve is provided to the brake system 100 of FIG. 1, though that person of ordinary skill in the art could readily provide a suitable simulator test valve or other simulator test capacity, as desired for a particular use environment.

It should be noted, though, that a brake simulator loop 140 placing the first MC chamber 128A and the reservoir 104 in hydraulic connection could be provided, as shown in FIGS. 2-3, for providing predetermined brake pedal response to the user. In this second type of brake simulator 140, of FIGS. 2-3, a reduced-diameter orifice could be used to provide the desired brake pedal response in a known manner as desired (e.g., during a fast pedal apply). One of ordinary skill in the art can readily configure a suitable brake simulator 140, in any desired format, for a particular use environment.

At least one electronic control unit (“ECU”) 144 may be provided for controlling at least one of the SCA power transmission units 116, at least one of the electric brake motors 126, and at least one of the normally open iso valves 134 responsive to at least one brake pressure signal, with first and second ECUs 144A, 144B being shown and described herein. The ECUs 144A, 144B may include microprocessors and other electrical circuitry. The ECUs 144A, 144B receive various signals, process signals, and control the operation of various electrical components of a corresponding brake system 100 in response to the received signals, in a wired and/or wireless manner. For example, the ECU(s) 144A and/or 144B may control at least one of the SCA power transmission units 115 and the iso valves 134 responsive to the braking signal generated by the brake pedal 112.

The ECUs 144A, 144B can be connected to various sensors such as the reservoir fluid level sensor 106, pressure sensors, travel sensors, switches, wheel speed sensors, and steering angle sensors. The ECUs 144A, 144B may also be connected to an external module (not shown) for receiving information related to yaw rate, lateral acceleration, longitudinal acceleration of the vehicle, or other characteristics of vehicle operation for any reason, such as, but not limited to, controlling the brake system 100 during vehicle braking, stability operation, or other modes of operation. Additionally, the ECUs 144A, 144B may be connected to the instrument cluster for collecting and supplying information related to warning indicators such as an ABS warning light, a brake fluid level warning light, and a traction control/vehicle stability control indicator light. It is contemplated that at least one of the ECUs 144A and 144B may be, for example, integrated into at least one of the secondary PTUs 116.

When there are two ECUs 144 provided to the brake system 100, the first ECU 144A may be operative to control the electric PTU motor 120 of at least a selected one of the single corner actuators 114, and/or any desired one(s) of the valves (e.g., iso valve [s] 134) of the brake system 100. The second ECU 144B may be operative to control the electric PTU motor 120 of at least one other SCA 114, and/or any desired one(s) of the valves (e.g., iso valve [s] 134) of the brake system 100. For example, the first ECU 144A may control at least a selected one of the normally open iso valves 134 and the second ECU 144B may control the at least one SCA power transmission unit 116 (and optionally at least an other one of the normally open iso valves 134). As another option, the first ECU 144A may control at least a selected one of the plurality of single corner actuators 114 and the second ECU 144B may control at least one of the electric brake motors 126. Regardless of the “division of labor” between the ECUs 144A, 144B, however, both the first and second ECUs 144A, 144B may control their respective normally open iso valve 134, at least one SCA power transmission unit 116, and/or electric brake motor(s) 126 responsive to at least one brake pressure signal. One of ordinary skill in the art can readily provide a suitable ECU 136 control arrangement, having any desired number and type(s) of ECUs, to achieve desired redundancy, slave/master, and/or backup functions for a particular use environment of the brake systems 100 shown and described herein.

Each of the single corner actuators 116 may be carried by a respective SCA housing, which is depicted schematically by dashed lines “SCA” in the Figures. The reservoir 104 and master cylinder 108 may be collectively carried by a primary housing, which is depicted schematically by dashed line “P” in the Figures. The primary housing and each SCA housing may all be spaced mutually apart from one another. It is contemplated that each SCA housing may be located immediately adjacent a corresponding wheel brake 102 RF or LF, as desired.

It is contemplated that various other components, such as electric service and/or parking brake motors, could be provided by one of ordinary skill in the art to achieve desired configurations for particular use environments, in any of the brake systems described herein. For example, while a number of filters and pressure sensors are shown in the Figures, specific description thereof has been omitted herefrom for brevity, as one of ordinary skill in the art will readily understand how to provide a desired number, placement, and/or operation of filters, sensors, and any other components as desired for a particular use environment of the present invention.

As used herein, the singular forms “a”, “an”, and “the” can include the plural forms as well, unless the context clearly indicates otherwise. It will be further understood that the terms “comprises” and/or “comprising”, as used herein, can specify the presence of stated features, steps, operations, elements, and/or components, but do not preclude the presence or addition of one or more other features, steps, operations, elements, components, and/or groups thereof.

As used herein, the term “and/or” can include any and all combinations of one or more of the associated listed items.

It will be understood that when an element is referred to as being “on”, “attached” to, “connected” to, “coupled” with, “contacting”, “adjacent”, etc., another element, it can be directly on, attached to, connected to, coupled with, contacting, or adjacent the other element, or intervening elements may also be present. In contrast, when an element is referred to as being, for example, “directly on”, “directly attached” to, “directly connected” to, “directly coupled” with, “directly contacting”, or “directly adjacent” another element, there are no intervening elements present. It will also be appreciated by those of ordinary skill in the art that references to a structure or feature that is disposed “directly adjacent” another feature may have portions that overlap or underlie the adjacent feature, whereas a structure or feature that is disposed “adjacent” another feature might not have portions that overlap or underlie the adjacent feature.

Spatially relative terms, such as “under”, “below”, “lower”, “over”, “upper”, “proximal”, “distal”, and the like, may be used herein for ease of description to describe one element or feature's relationship to another element(s) or feature(s) as illustrated in the figures. It will be understood that the spatially relative terms can encompass different orientations of a device in use or operation, in addition to the orientation depicted in the figures. For example, if a device in the figures is inverted, elements described as “under” or “beneath” other elements or features would then be oriented “over” the other elements or features.

As used herein, the phrase “at least one of X and Y” can be interpreted to include X, Y, or a combination of X and Y. For example, if an element is described as having at least one of X and Y, the element may, at a particular time, include X, Y, or a combination of X and Y, the selection of which could vary from time to time. In contrast, the phrase “at least one of X” can be interpreted to include one or more Xs.

It will be understood that, although the terms “first”, “second”, etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

While aspects of this disclosure have been particularly shown and described with reference to the example aspects above, it will be understood by those of ordinary skill in the art that various additional aspects may be contemplated. For example, the specific methods described above for using the apparatus are merely illustrative; one of ordinary skill in the art could readily determine any number of tools, sequences of steps, or other means/options for placing the above-described apparatus, or components thereof, into positions substantively similar to those shown and described herein. In an effort to maintain clarity in the Figures, certain ones of duplicative components shown have not been specifically numbered, but one of ordinary skill in the art will realize, based upon the components that were numbered, the element numbers which should be associated with the unnumbered components; no differentiation between similar components is intended or implied solely by the presence or absence of an element number in the Figures. Any of the described structures and components could be integrally formed as a single unitary or monolithic piece or made up of separate sub-components, with either of these formations involving any suitable stock or bespoke components and/or any suitable material or combinations of materials. Any of the described structures and components could be disposable or reusable as desired for a particular use environment. Any component could be provided with a user-perceptible marking to indicate a material, configuration, at least one dimension, or the like pertaining to that component, the user-perceptible marking potentially aiding a user in selecting one component from an array of similar components for a particular use environment. A “predetermined” status may be determined at any time before the structures being manipulated actually reach that status, the “predetermination” being made as late as immediately before the structure achieves the predetermined status. The term “substantially” is used herein to indicate a quality that is largely, but not necessarily wholly, that which is specified—a “substantial” quality admits of the potential for some relatively minor inclusion of a non-quality item. Though certain components described herein are shown as having specific geometric shapes, all structures of this disclosure may have any suitable shapes, sizes, configurations, relative relationships, cross-sectional areas, or any other physical characteristics as desirable for a particular application. Any structures or features described with reference to one aspect or configuration could be provided, singly or in combination with other structures or features, to any other aspect or configuration, as it would be impractical to describe each of the aspects and configurations discussed herein as having all of the options discussed with respect to all of the other aspects and configurations. A device or method incorporating any of these features should be understood to fall under the scope of this disclosure as determined based upon the claims below and any equivalents thereof.

Other aspects, objects, and advantages can be obtained from a study of the drawings, the disclosure, and the appended claims.

I claim:

1. A brake system for actuating a plurality of wheel brakes comprising at least first and second wheel brakes, the system comprising:
a reservoir;
a master cylinder in fluid communication with the reservoir and operable during a backup braking mode to generate pressurized hydraulic fluid at at least one MC output for hydraulically actuating the first and second wheel brakes;
a plurality of single corner actuators, each single corner actuator being hydraulically interposed between the at least one MC output and a corresponding one of the first and second wheel brakes, each single corner actuator including
a SCA power transmission unit configured for selectively providing pressurized hydraulic fluid at an SCA output for actuating the respective wheel brake in at least one of a normal non-failure braking mode and a backup braking mode, the SCA power transmission unit including an electric PTU motor configured to selectively pressurize the hydraulic fluid by transmitting rotary motion to a plunger assembly of the SCA power transmission unit, and
a plurality of satellite reservoirs, each satellite reservoir being interposed hydraulically between the SCA power transmission unit and the master cylinder along the at least one MC output; and
an electronic control unit for controlling at least one SCA power transmission unit responsive to at least one brake pressure signal;
wherein each single corner actuator is indirectly fluidly connected to the reservoir via the master cylinder and the satellite reservoir.

2. The brake system of claim 1, wherein the master cylinder is operable to generate pressurized fluid via manual force applied to a brake pedal by a user.

3. The brake system of claim 1, including third and fourth wheel brakes, each of the third and fourth wheel brakes being actuated by an electric brake motor.

4. The brake system of claim 3, wherein the electronic control unit is a first electronic control unit controlling at least a selected one of the plurality of single corner actuators and the brake system includes a second electronic control unit controlling the electric brake motors, wherein both the first and second electronic control units control the respective at least one of the plurality of single corner actuators and the electric brake motors responsive to at least one brake pressure signal.

5. The brake system of claim 1, wherein each of the single corner actuators is carried by a respective SCA housing, the reservoir and master cylinder are collectively carried by a primary housing, and the primary housing and each SCA housing are all spaced mutually apart from one another.

6. The brake system of claim 1, wherein the reservoir is a single-chamber reservoir.

7. The brake system of claim 1, wherein each single corner actuator includes a brake pressure sensor for sensing hydraulic pressure at the plunger assembly of the SCA power transmission unit and responsively producing a brake pressure signal.

8. The brake system of claim 1, wherein the brake pedal is configured to provide a braking signal, in a wired or wireless manner, corresponding to a desired braking action by an operator of the vehicle, wherein the electronic control unit controls at least one of the plurality of single corner actuators and the electric brake motors responsive to the braking signal.

9. The brake system of claim 1, wherein the master cylinder is a single chamber master cylinder including an MC chamber and an MC plunger configured for reciprocal motion therein to provide pressurized hydraulic fluid at a single-chamber output serving as the at least one MC output.

10. The brake system of claim 9, wherein the at least one MC output is in fluid communication with the single corner actuators via a single normally open iso valve interposed hydraulically between the master cylinder and at least a selected one of the plurality of single corner actuators for selectively controlling provision of hydraulic fluid to the respective wheel brake from the master cylinder.

11. The brake system of claim 1, wherein the master cylinder is a dual master cylinder including first and second MC chambers and corresponding first and second MC plungers configured for reciprocal motion therein, the at least one MC output comprises first and second single-chamber outputs, and the second MC chamber provides pressurized hydraulic fluid at the first and second single-chamber outputs.

12. The brake system of claim 11, wherein the first and second MC plungers each have substantially different outer circumference sizes.

13. The brake system of claim 1, including at least one normally open iso valve interposed hydraulically between the master cylinder and at least a selected one of the plurality of single corner actuators for selectively controlling provision of hydraulic fluid to the respective wheel brake from the master cylinder.

14. The brake system of claim 13, wherein the at least one normally open iso valve comprises a single iso valve interposed hydraulically between the master cylinder and the at least one satellite reservoir.

15. The brake system of claim 13, wherein the at least one normally open iso valve includes a check valve feature when the valve is energized closed.

16. The brake system of claim 13, wherein the at least one normally open iso valve comprises first and second iso valves, with each iso valve being hydraulically interposed between the master cylinder and a corresponding one of the plurality of satellite reservoirs.

17. The brake system of claim 13, wherein the at least one normally open iso valve comprises first and second iso valves, with each iso valve being hydraulically interposed between a corresponding one of the plurality of satellite reservoirs and a corresponding one of the SCA power transmission units.

18. The brake system of claim 1, including a brake simulator in fluid communication with the at least one MC output and with the reservoir for providing predetermined brake pedal response to the user.

19. The brake system of claim 18, including a brake simulator valve interposed hydraulically between the at least one MC output and the brake simulator for controlling fluid transfer therebetween.

20. The brake system of claim 11, including a brake simulator loop placing the first MC chamber and the reservoir in hydraulic connection for providing predetermined brake pedal response to the user.
